(19) United States
(12) Patent Application Publication
(10) Pub. No.: US 2019/0036418 A1
(43) Pub. Date: Jan. 31, 2019

(54) Permanent-Magnet Synchronous Machine with Automatic Rotor Decoupling in the Winding Short Circuit

(71) Applicant: Siemens Aktiengesellschaft, Muenchen (DE)

(72) Inventors: Christoph ADAM, Nuernberg (DE); Andre JANSEN, Nuernberg (DE); Olaf KOERNER, Borken (DE)

(21) Appl. No.: 16/064,247

(22) PCT Filed: Nov. 10, 2016
(86) PCT No.: PCT/EP2016/077311

§ 371 Date: Oct. 10, 2018

(30) Foreign Application Priority Data
Dec. 23, 2015 (EP) 15202269.5

(51) Int. Cl. H02K 7/00; H02K 7/08; H02K 11/27; H02K 11/25; H02K 11/26; H02K 11/24; H02K 21/14; B61C 3/00

(52) U.S. Cl. CPC H02K 7/003; H02K 7/085; H02K 11/27; B61C 3/00; H02K 11/26; H02K 11/24; H02K 21/14; H02K 11/25

(57) ABSTRACT

A permanent-magnet synchronous machine includes a stator in which a stator winding is arranged, a rotor which can rotate about a rotation axis and in which permanent magnets are arranged, wherein the rotor is connected to a motor shaft via a connecting device which is formed such that it initially connects the rotor to the motor shaft in a rotationally fixed manner, such that a torque which is generated by the interaction of stator winding and permanent magnet is transmitted to the motor shaft, where the connecting device is further configured automatically break the rotationally fixed connection of the rotor in the event of a short circuit of the stator winding, such that a torque that acts on the motor shaft is no longer transmitted to the rotor.

### CROSS-REFERENCE TO RELATED APPLICATIONS

This is a U.S. national stage of application No. PCT/EP2016/077311 filed Nov. 10, 2016. Priority is claimed on EP Application No. 15202269 filed Dec. 23, 2015, the content of which is incorporated herein by reference in its entirety.

### BACKGROUND OF THE INVENTION

### 1. Field of the Invention

The present invention relates to a permanent-magnet synchronous machine, where the synchronous machine has a stator, in which a stator winding is arranged, a rotor that is rotatable about an axis of rotation, in which permanent magnets are arranged and that is connected to a motor shaft via a connecting device, and where the connecting device is configured to connect the rotor to the motor shaft in a torsion-proof manner, such that torque generated by the interaction of stator winding and the permanent magnets is transmitted to the motor shaft.

The present invention also relates to a land vehicle, where the land vehicle has a number of propulsion drives, which each have a synchronous machine and which each drive one wheel of the land vehicle via the synchronous machine.

### 2. Description of the Related Art

With land vehicles (this particularly applies rail vehicles, but is not necessarily restricted to rail vehicles however), there are often many converters and electric motors present, which each drive one wheel of a wheel set. If an individual converter or electric motor fails, then the land vehicle continues to operate without the failed converter or the failed electric motor. If the electric motor is a permanent-magnet synchronous motor and an electric motor of this type fails with a winding short circuit, i.e., a short circuit occurs in the stator winding, in the prior art the associated converter is switched off and is disconnected for the electric motor. After the converter has been switched off, an external voltage is no longer supplied to the failed electric motor. However, the rotation is still imparted to the rotor by the moving vehicle via the wheel-to-rail contact or via the wheel-to-ground contact. The permanent magnets arranged in the rotor therefore induce voltage in the stator winding. The induced voltage drives a fault current via the fault point at which the short circuit has occurred. This often causes arcs and/or high thermal losses to occur. As a consequence, the insulation of the stator winding can overheat and burn. Also the copper of the stator winding can also start to melt under some circumstances. Over and above these effects, already seen as negative per se, noise (actually harmless in itself) can also be generated which, for example, can cause considerable annoyance to passengers in a rail vehicle.

It is therefore of advantage, in the event of a winding short circuit, to disconnect the rotor (more precisely, the active part of the rotor) from the rotating wheel, so that the active part no longer rotates. Then, as a result of the absence of rotation in the stator winding, voltage is also no longer induced, such that consequential damage no longer occurs beyond the winding short circuit.

Safety couplings to decouple the driving motor from the drive train in the event of a fault are known. These are mostly switched separately (actively), however.

DE 10 2013 104 558 A1 discloses a drive train for a rail vehicle, which comprises a wheel set shaft and a large wheel to transmit a torque from a drive unit to the wheel set shaft. In this drive train, an overload coupling is connected to the wheel set shaft in a torsion-proof manner. The overload coupling couples the large wheel in a torsion-proof manner to the wheel set shaft. The overload coupling has a predetermined switching torque. If this switching torque is exceeded, then the overload coupling releases the large wheel in relation to the wheel set shaft. As taught in DE 10 2013 104 558 A1, the wheel set shaft is therefore released from the drive if a mechanically effective torque is exceeded. This embodiment is not suitable for a disconnection in the event of a winding short circuit.

### SUMMARY OF THE INVENTION

It is an object of the present invention to provide a permanent-magnet synchronous machine configured such that, in the event of a winding short circuit, torque transmission from the motor shaft to the rotor of the permanent-magnet synchronous machine can be suppressed in a simple and reliable way.

This and other objects and advantages are achieved in accordance with the invention by a permanent-magnet synchronous machine in which a connecting device is configured such that it initially only connects a rotor to a motor shaft in a torsion-proof manner, such that torque generated by the interaction of a stator winding and permanent magnets is transmitted to the motor shaft, and the connecting device is configured such that, in the event of a short circuit of the stator winding, it automatically releases the torsion-proof connection of the rotor, such that torque acting on the motor shaft is no longer transmitted to the rotor.

As a result of this embodiment, in the event of a winding short circuit, and automatic release of the torsion-proof connection of the rotor to the motor shaft occurs. The disadvantages stated above are therefore avoided.

The motor shaft can be identical to the rotor shaft, i.e., that shaft on which the rotor is arranged. As an alternative, the shaft can involve another shaft. In any event, however, the motor shaft is that shaft via which a torque is output by the permanent-magnet synchronous machine.

In a possible embodiment of the synchronous machine, a rotor is arranged in a torsion-proof manner on a rotor shaft different from the motor shaft, the motor shaft including a hub enclosing the rotor shaft, a bearing is arranged between the rotor shaft and the hub, the connecting device comprises a retaining element, via which the hub is initially pressed radially onto the rotor shaft, such that, as a result of the pressing, the torque generated by the interaction of stator winding and permanent magnets is transmitted to the motor shaft, and the retaining element consists at least partly of a material of which the strength and/or cohesion is reduced such that, in the event of a short circuit of the stator winding resulting from an overheating of the stator winding that occurs and/or arcs occurring, the pressing of the hub onto the rotor shaft is reversed.

The advantage of this embodiment is that the rotor, as is also usual, can be arranged in a torsion-proof manner on the rotor shaft.

In this embodiment, the retaining element can be formed as the bandage surrounding the hub radially externally. A possible material of the bandage is a glass fiber mat or carbon fiber mat impregnated with a hardener. A melting temperature of the hardener in this case should lie between around 200° C. and around 300° C., in particular between around 250° C. and around 280° C. These types of hardeners are known to persons skilled in the art. An example of suitable hardener is especially a hardener of which the “glass temperature” lies in this range. Thermoplastics can be chosen as these types of hardeners.

The bearing between the rotor shaft and the hub makes it possible for no damage to occur during continuation of the journey of the land vehicle and thus in particular on continuation of the rotation of the motor shaft, in particular for a free rotation of the motor shaft relative to the rotor shaft to be possible. Preferably, the bearing is configured as an emergency bearing. Because of its configuration as an emergency bearing the bearing between the motor shaft and the rotor shaft can be formed simply and at very low cost. The emergency bearing, on the other hand, does not have to be able to guarantee continuous operation over days, weeks and months. It is sufficient to be able to continue the journey of the land vehicle, for example, to the next repair facility.

In a further possible embodiment of the synchronous machine, the rotor is supported rotatably on the motor shaft, the connecting device, comprise a ring, which is connected to the rotor in a torsion-proof manner at an axial end of the rotor, the connecting device comprises at least one bolt, which is arranged partly in a recess of the ring and partly in a recess of the motor shaft, such that the torque generated by the interaction of the stator winding and permanent magnet is transferred via the bolt to the motor shaft, the connecting device comprises a retaining element, via which a radial displacement of the bolt from the recess of the motor shaft is initially prevented, and the retaining element consists at least partly of a material of which the strength and/or cohesion is reduced far such that, in the event of a short circuit of the stator winding due to an overheating of the stator winding that occurs and/or an occurrence of arcs, the bolt is displaced out of the recess of the motor shaft.

The advantage of this embodiment is that the torque applied by the synchronous machine during normal operation (i.e., when the torsion-proof connection exists between rotor and motor shaft) is transferred via the bolts. On the other hand, only the forces exerted by the bolts on the retaining element and centrifugal forces act on the retaining element. These forces are very small, however.

The retaining element can be formed in this case, for example, as the bandage surrounding the ring radially externally. The possible materials of the bandage have already been mentioned above.

Preferably, the connecting device has at least one compression spring, via which a force directed radially outwards is exerted on the bolt. The effect of this is that, when the strength and/or the cohesion of the retaining element is reduced, the bolt is actively pressed radially outwards by the compression spring. The compression spring can be formed, for example,—via a suitable configuration or by a stop, such that, after the bolt has been pushed out of the motor shaft, it does not project into the ring itself. As an alternative, the compression spring can be dimensioned such that, although it pushes the bolt out of the motor shaft, and thereafter projects into the ring itself, it cannot transfer any appreciable torque however, but is sheared off itself beforehand for example.

It is currently especially preferred to embody the synchronous machine such that the rotor is rotatably supported on the motor shaft, the connecting device comprises a first coupling part, which is arranged on the motor shaft in a torsion-proof manner, the connecting device comprises a second coupling part, which is connected to the rotor in a torsion-proof manner, the connecting device comprises a retaining element penetrating the first and the second coupling part axially, via which the first coupling part is initially pushed axially against the second coupling part, such that the torque generated by the interaction of the stator winding and permanent magnets is transmitted to the motor shaft by the first and second coupling part, and the retaining element consists at least partly of a material, of which the strength and/or cohesion, in the event of a short circuit of the stator winding, is reduced far enough by an overheating of the stator winding that occurs and/or by the occurrence of arcs, for a pressure exerted by the retaining element on the first and the second coupling element to be reduced far enough for it to make possible a displacement of the first and the second coupling element away from each other.

This embodiment has the advantage in particular that the release of the connecting element, i.e., the removal of the torsion-proof connection of the rotor to the motor shaft, can be initiated reliably, where the initiation is independent of the axial position at which the winding short circuit has occurred and at which consequently the greatest amount of heat develops. Experience shows, in particular that, when the winding short circuit occurs, this generally occurs in one of the two winding heads.

The retaining element can be formed as a number of bandages. The possible materials of the bandages have already been explained above.

As an alternative it is possible, for the retaining element to be formed as a number of bolts, which are secured at the two axial ends by fixing elements, and for the fixing elements to consist of a material of which the strength and/or cohesion is reduced in the event of a short circuit of the stator winding through the occurrence of overheating of the stator winding and/or the occurrence of arcs.

The fixing elements can be formed as fuses, for example. The fuses can consist of a soft solder that has a suitable solidus temperature, for example. The various soft solders are known to persons skilled in the art, where the solders have solidus temperatures of between 138° C. and 308° C. Within the framework of the current invention, soft solders with a solidus temperature of between 200° C. and 300° C., in particular of between 250° C. and 280° C., are suitable. For example, a eutectic mixture of 99.3% tin and 0.7% copper has a melting point of 227° C. The same applies for a eutectic mixture of 99.0% tin, 0.3% silver and 0.7% copper. Pure tin has a melting point of 232° C., a mixture of 89% tin, 10.5% antimony and 0.5% copper has a solidus temperature of 242° C. Each of these soft solders can be used as the material for a fuse. Other soft solders with a higher or a lower solidus temperature can also be used, as required. Likewise suitable plastics can be used, such as PEEK.

Preferably, at least one compression spring is arranged between the first and the second coupling part, via which a force driving the first and the second coupling part apart from one another is exerted on the first and the second coupling part. The effect of this is that when the strength and/or the cohesion of the retaining element is reduced, the coupling parts are actively pushed away from one another by the compression spring.

The bearing via which the rotor is supported on the motor shaft is preferably formed as an emergency bearing. As a result of the embodiment as an emergency bearing, the support of the rotor on the motor shaft can be formed simply and at very low cost. The emergency bearing, on the other hand, does not have to guarantee continuous operation over days, weeks and months. It is sufficient to be able to continue the current journey of the land vehicle for a period of time.

It is also an object of the invention to provide a land vehicle of the type stated at the outset which is configured with the drives having an inventive synchronous machine.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The characteristics, features and advantages described above as well as the manner in which these are achieved will become clearer and easier to understand in conjunction with the description of the exemplary embodiments given below, which will be explained in greater detail in conjunction with the drawings, in which:

FIG. 1 shows a land vehicle in accordance with the invention;

FIG. 2 shows a permanent-magnet synchronous machine in accordance with the invention;

FIG. 3 shows a possible embodiment of a rotor arrangement of the synchronous machine of FIG. 2;

FIG. 4 shows a further possible embodiment of a rotor arrangement of the synchronous machine of FIG. 2; and

FIG. 5 shows a further possible embodiment of a rotor arrangement of the synchronous machine of FIG. 2.

### DETAILED DESCRIPTION OF THE EXEMPLARY EMBODIMENTS

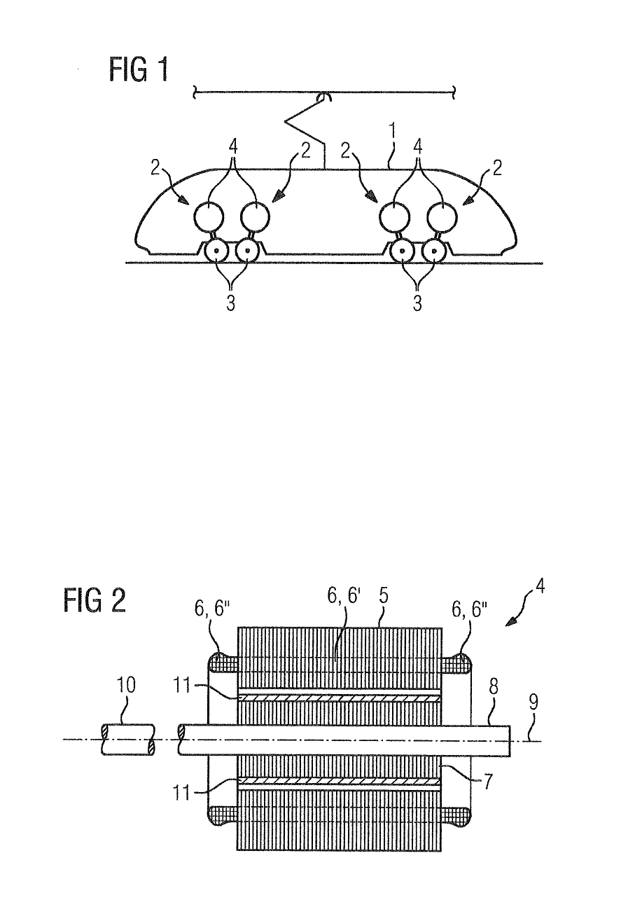

In accordance with FIG. 1, a land vehicle 1 has a number of propulsion drives 2. The propulsion drives 2 each drive at least one wheel 3 of the land vehicle 1. The propulsion drives 2, in order to drive the respective wheel 3, each have a synchronous machine 4. As a rule, respective synchronous machine 4 is fed via a respective converter. The converters are also not shown in the figure.

As depicted in the diagram in FIG. 1, the land vehicle 1 comprises a rail vehicle. This embodiment, within the framework of the present invention for a land vehicle, represents the normal case. The present invention, however, can also be used when the land vehicle 1 is not rail-bound, such as when the land vehicle 1 comprises an electric automobile and each wheel of the electric automobile has its own drive.

In accordance with FIG. 2 the synchronous machine 4 has a stator 5. Arranged in the stator 5 is a stator winding 6. The stator winding 6 has a central part 6′ and also two winding heads 6″. The central part 6′ of the stator winding 6 is that part of the stator winding 6 that is located in the stator 5 itself. The winding heads 6″ are those parts of the stator winding 6 that project axially beyond the stator 5.

The synchronous machine 4 further has a rotor 7. The rotor 7 is arranged on a shaft 8. The shaft 8 and with it the rotor 7 are rotatable about an axis of rotation 9. In many embodiments of the present invention, which will be explained in conjunction with the further figures, the shaft 8 involves the motor shaft 10 of the synchronous machine 4. In other embodiments, a separate shaft different from the motor shaft 10 is involved. In this case, the shaft 8 is flush with the motor shaft 10, meaning that the axis of rotation 9 of the shaft 8 is identical to the axis of rotation of the motor shaft 10. Arranged in the rotor 7 are permanent magnets 11. The synchronous machine 4 is therefore formed as a permanent-magnet synchronous machine. The permanent magnets 11 or their magnetic field and a rotating field generated by applying power to the stator winding 6 act together in the operation of the synchronous machine 4 to create a torque.

The terms “axial”, “radial” and “tangential” are always related to the axis of rotation 9. “Axial” is a direction parallel to the axis of rotation 9. “Radial” is a direction orthogonal to the axis of rotation 9 on the axis of rotation 9 towards it or away from it. “Tangential” is a direction which runs both orthogonally to the axial direction and also orthogonally to the radial direction. Thus “tangential” means a direction that, with a constant axial position and with a constant radial distance, is directed in a circular shape about the axis of rotation 9.

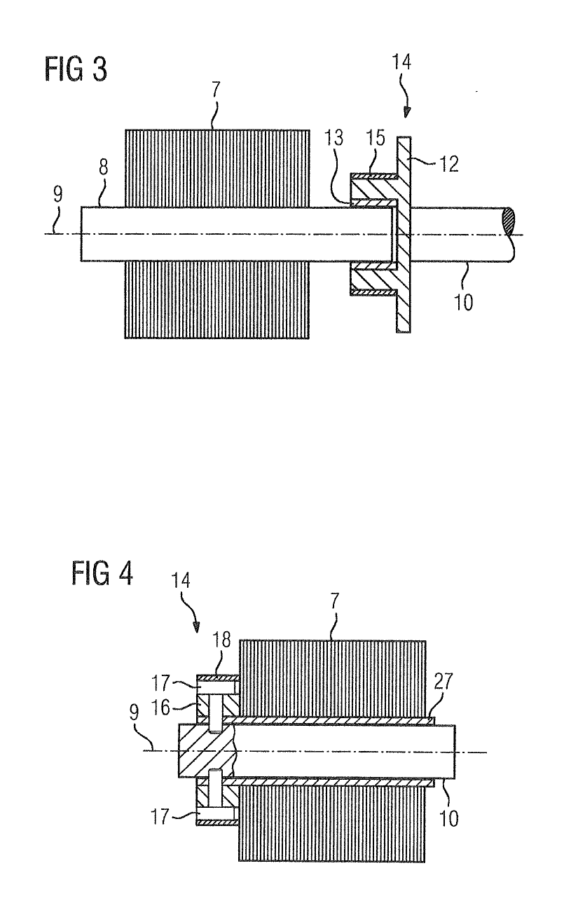

Within the framework of the embodiment in accordance with FIG. 3, the shaft 8 is a separate shaft, i.e., a different shaft from the motor shaft 10. Within the framework of the embodiment in accordance with FIG. 3, the shaft 8 will be referred to below as the rotor shaft. The rotor 7 is arranged in a torsion-proof manner on the rotor shaft 8. The motor shaft 10 has a hub 12. The hub 12 encloses the rotor shaft 8. Arranged between the rotor shaft 8 and the hub 12 is a bearing 13. In principle, the rotor shaft 8 is therefore rotatable relative to the hub 12. The bearing 13 can be formed in particular as an emergency bearing.

The rotor 7 is connected (indirectly via the rotor shaft 8) to the motor shaft 10 via a connecting device 14. The connecting device 14, within the framework of the embodiment in accordance with FIG. 3, initially comprises the hub 12. Furthermore, the connecting device 14 comprises a retaining element 15. The hub 12 is pressed radially onto the rotor shaft 8 via the retaining element 15. As a result of the pressing, it is possible to transmit the torque, which is generated by the interaction of stator winding 6 and permanent magnets 11, onto the motor shaft 10. The connecting device is thus configured such that it (initially) connects the rotor 7 to the motor shaft 10 in a torsion-proof manner. The retaining element 15 generally brings about a friction-fit connection, in some cases a form-fit connection, of the rotor shaft 8 to the motor shaft 10.

The retaining element 15, however, consists at least partly (preferably completely) of a material of which the strength and/or cohesion is reduced such that, in the event of a short circuit of the stator winding 6 due to an overheating of the stator winding 6 that occurs and/or an occurrence of arcs, the pressing of the hub on the rotor shaft is reversed. For example, the retaining element 15 can be formed as a bandage made of a type of material that surrounds the outside of the hub 12 radially. If the bandage heats up as a result of a winding short circuit and the fault currents occurring as a result, the bandage loses its strength.

The pressing is removed such that the rotor shaft 8 becomes rotatable relative to the motor shaft 10 via the bearing 13. With subsequent cooling of the bandage, although this hardens again, the previous torsion-proof connection between motor shaft 10 and rotor shaft 8 (and via the rotor shaft 8 further to the rotor 7) will not be re-established, however. Instead, the connection remains removed. The connecting device 14 is thus configured such that, in the event of a short circuit of the stator winding 6, it automatically releases the torsion-proof connection of the rotor 7, such that torque acting on the motor shaft 10 is no longer transmitted to the rotor 7.

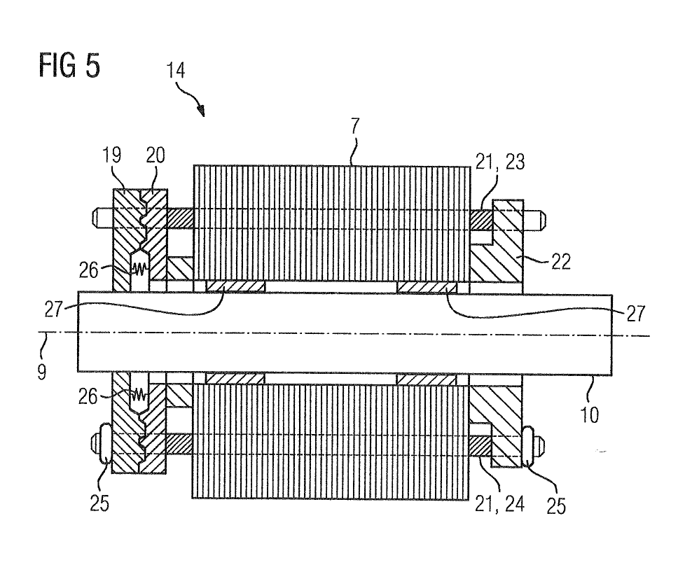

Further possible embodiments of the synchronous machine 4 will be explained below in conjunction with FIGS. 4 and 5. In these embodiments the rotor is supported directly on the motor shaft 10 to allow it to rotate. In these embodiments, however, the rotor 7 is also connected to the motor shaft 10 via the connecting device 14. The connecting device 14, like the embodiment in accordance with FIG. 3, is configured such that it (initially) connects the rotor 7 to the motor shaft 10 in a torsion-proof manner. In this state, it is thus possible for a torque that is generated by the interaction of stator winding 6 and permanent magnets 11 to be transmitted to the motor shaft 10. The connecting device 14 is, however, both in the embodiment in accordance with FIG. 4 and in the embodiment in accordance with FIG. 5, configured such that, in the event of a short circuit of the stator winding 6, the connecting device 14 automatically releases the torsion-proof connection of the rotor 7. Torque acting on the motor shaft 10 is then no longer transmitted to the rotor 7. With these embodiments, after the torsion-proof connection has been released, the connection also stays released.

In the embodiment in accordance with FIG. 4, the connecting device 14 comprises a ring 16, which is connected to the rotor 7 in a torsion-proof manner at an axial end of the rotor 7. The ring 16 has at least one recess. Two recesses of this kind are shown in FIG. 4. Mostly three or four recesses are present. Furthermore, the motor shaft 10 has a corresponding recess in each case for each recess of the ring 16.

A single recess of the ring 16 and the corresponding recess of the motor shaft 10 will always be referred to below. The corresponding information also applies even if the ring 16 and the motor shaft 10 each have a number of recesses.

Both the recess of the ring 16 and the recess of the motor shaft 10 run radially. A bolt 17 is introduced into the recess of the ring 16. The bolt 17 extends through the recess of the ring 16 into the corresponding recess of the motor shaft 10. The bolt 17 is thus arranged partly in the recess of the ring 16 and partly in the recess of the motor shaft 10. The bolt causes a form-fit connection of the rotor 7 and the motor shaft 10. The torque generated by the interaction of stator winding 6 and permanent magnets 11 can thus be transferred via the bolt 17 to the motor shaft 10.

The transmission of the torque is of course only possible for as long as the bolt 17 is arranged in both recesses (i.e., both in the recess of the ring 16 and in the recess of the motor shaft 10). Furthermore, centrifugal forces act on the bolt 17 during rotation of the motor shaft 10. The connecting device 14 therefore comprises a retaining element 18, via which a radial displacement of the bolt 17 out of the recess of the motor shaft 10 is (initially) prevented. The retaining element 18 can be formed, as depicted in FIG. 4, as a bandage, which surrounds the outside of the ring 16 radially. In a similar way to the embodiment in accordance with FIG. 3, the retaining element 18 consists at least partly (preferably even completely) of a material of which the strength and/or cohesion is reduced in the event of a short circuit of the stator winding 6 due to an overheating of the stator winding 6 that occurs and/or an occurrence of arcs. The above information about the retaining element 15 of the embodiment of FIG. 3 is usable in a similar way.

In the event of a short circuit of the stator winding 6, the retaining element 18 thus loses its capability to hold back the bolt 17. This enables the bolt 17 to move out of the recess of the motor shaft 10. In a later cooling down of the bandage, the bandage does re-harden. However, the bolt 17 is not pushed back into the recess of the motor shaft 10. The bold 17 can actually, under some circumstances, fall back into the recess as a result of centrifugal forces. At the latest, with a new rotation of the motor shaft 10, it will be moved out of the recess of the motor shaft 10 again by the centrifugal forces occurring. If necessary (this is not also shown in FIG. 4), the connecting device can furthermore have a compression spring, via which a force directed radially outwards is exerted. The compression spring is arranged in this case within the motor shaft 10.

FIG. 5 shows a further embodiment of the rotor arrangement of the synchronous machine 4. This embodiment is currently especially preferred. In the embodiment in accordance with FIG. 5, the connecting device 14 comprises a first coupling part 19 and a second coupling part 20. The first coupling part is arranged on the motor shaft 10 in a torsion-proof manner. The second coupling part 20 is connected to the rotor 7 in a torsion-proof manner. The connecting device 14 furthermore comprises a retaining element 21. The retaining element 21 penetrates both the rotor 7 and the first coupling part 19 and also the second coupling part 20 axially. A pressure ring 22 is mostly arranged on the other side of the rotor 7 facing away from the coupling parts 19, 20, which is also penetrated axially by the retaining element 21. The retaining element 21 is under compressive tension. With the retaining element 21, the first coupling element 19 is therefore (initially) pressed against (tensioned on) the second coupling element 20. The fact that the retaining element 21 presses the coupling elements 19, 20 against one another means that it is possible to transmit the torque generated by the interaction of stator winding 6 and permanent magnets 11 to the motor shaft 10. The torque is thus transmitted by the interaction of first and second coupling part 19, 20. As a rule, a friction-fit connection, in some cases a form-fit connection, of the rotor 7 to the motor shaft exists via the coupling parts 19, 20.

As in the embodiments of FIGS. 3 and 4, in the embodiment of FIG. 5, the retaining element also consists of a material of which the strength and/or cohesion, in the event of a short of the stator winding 6, is reduced such that, by the overheating of the stator winding 6 that occurs and/or an occurrence of arcs, a pressure exerted by the retaining element 21 on the first and the second coupling part 19, 20 is reduced. The pressure is in particular reduced far enough for the retaining element to make possible an axial displacement of the first and second coupling part 19, 20 away from one another. The coupling parts 19, 20 are thereby no longer connected to one another in a torsion-proof manner, such that a rotation of the motor shaft is decoupled from a rotation of the rotor 7. The retaining element 21 (depending on its embodiment) can, for example, move out of the coupling parts 19, 20, release itself or shear off.

In the embodiment in accordance with FIG. 5, the retaining element 21 can be formed as a number of bandages 23. This is shown for a single bandage 23 in the upper part of FIG. 5. What has been stated above in conjunction with FIG. 3 and FIG. 4 applies analogously for the embodiment of the bandages 23 as such.

As an alternative, the retaining element 21 can be formed as a number of bolts 24 that are secured at both axial ends by fixing elements 25. This is shown in the lower part of FIG. 5. The bolts 24 consist of steel or another suitable material. The strength and the cohesion of the bolts 24 is maintained even in the event of a short circuit of the stator winding 6. The fixing elements 25, however, consist of a material of which the strength and/or cohesion is reduced in the event of a short circuit of the stator winding 6 due to the overheating of the stator winding 6 that occurs and/or by the occurrence of arcs. In particular, the fixing elements 25 can comprise fuse links.

Preferably, in accordance with the embodiment shown in FIG. 5, compression springs 26 are arranged between the first and the second coupling part 19, 20. With the compression springs 26, a force driving the first and the second coupling part 19, 20 away from one another can be exerted on the first and second coupling parts 19, 20. This enables it to be insured that the coupling formed by the coupling parts 19, 20 opens immediately when the fixing elements 25 on the one side or on the other side of the rotor 7 lose their strength or their cohesion.

Within the framework of the embodiments of FIG. 4 and FIG. 5, the rotor 7 is supported on the motor shaft 10 via a bearing 27. The bearing 27 is preferably formed as an emergency bearing.

In summary the present invention thus relates to a permanent-magnet synchronous machine 4 having a stator 5, in which a stator winding 6 is arranged. The synchronous machine 4 has a rotor 7 that is rotatable about an axis of rotation 9, in which permanent magnets 11 are arranged. The rotor 7 is connected to a motor shaft 10 via a connecting device 14. The connecting device 14 is configured such that it initially connects the rotor 7 to the motor shaft 10 in a torsion-proof manner, such that torque generated by the interaction of stator winding 6 and permanent magnets 11 is transferred to the motor shaft 10. The connecting device 14 is furthermore configured such that, in the event of a short circuit of the stator winding 6, the connecting device 14 automatically releases the torsion-proof connection of the rotor 7, such that a torque acting on the motor shaft 10 is no longer transmitted to the rotor 7.

The present invention has many advantages. In particular, it is simple to implement. Furthermore, in the event of a winding short circuit, the torsion-proof connection of the rotor 7 to the motor shaft 10 can be removed in a simple and reliable way.

Although the invention has been illustrated and described in greater detail by the preferred exemplary embodiments, the invention is not restricted solely to the disclosed examples and other variations can be derived therefrom by the person skilled in the art, without departing from the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A permanent-magnet synchronous machine, comprising:
a stator;
a stator winding arranged in the stator;
a rotor which rotatable about an axis of rotation;
permanent magnets arranged in the rotor;
a motor shaft connected to the rotor via a connecting device;
wherein the connecting device is formed to initially connect the rotor to the motor shaft in a torsion-proof manner, such that a torque generated by interaction of the stator winding and permanent magnets is transmitted to the motor shaft; and
wherein the connecting device comprises a retaining element which consists at least partly of a material of which at least one of (i) a strength and (ii) cohesion is reduced such that, in an event of a short circuit of the stator winding, by at least one of (i) an occurrence of overheating of the stator winding and at least one of (ii) an occurrence of arcs, a torque acting on the motor shaft no longer becomes transmitted to the rotor.

15. The synchronous machine as claimed in claim 14, wherein the rotor is arranged in a torsion-proof manner on a second rotor shaft different from the motor shaft,
wherein the motor shaft includes a hub which encloses the rotor shaft, a bearing being arranged between the second rotor shaft and the hub;
wherein the connection device comprises a retaining element, via which the hub is initially pressed radially onto the second rotor shaft, such that as a result of pressure, the torque generated by the interaction of the stator winding and the permanent magnets is transmitted to the motor shaft; and
wherein the retaining element consists at least partly of a material of which at least one of (i) a strength and (ii) cohesion is reduced such that, in the event of the short circuit of the stator winding, by at least one of (i) the occurrence of overheating of the stator winding and (ii) the occurrence of arcs, pressure of the hub on the rotor shaft becomes removed.

16. The synchronous machine as claimed in claim 15, wherein the retaining element is formed as a bandage radially surrounding an outside of the hub.

17. The synchronous machine as claimed in claim 15, wherein the bearing between the rotor shaft and the hub comprises an emergency bearing.

18. The synchronous machine as claimed in claim 16, wherein the bearing between the rotor shaft and the hub comprises an emergency bearing.

19. The synchronous machine as claimed in claim 14, wherein the rotor is supported to rotate on the motor shaft;
wherein the connecting device comprises a ring, which is connected to the rotor in a torsion-proof manner at an axial end of the rotor;
wherein the connecting device comprises at least one bolt, which is arranged partly in a recess of the ring and partly in a recess of the motor shaft, such that the torque generated by the interaction of stator winding and the permanent magnets is transmitted via the at least one bolt to the motor shaft;
wherein the connecting device comprises a retaining element via which a radial displacement of the at least one bolt from the recess of the motor shaft is initially prevented; and
wherein the retaining element consists at least partly of a material, of which at least one of (i) the strength and (ii) the cohesion is reduced such that, in the event of the short circuit of the stator winding, by at least one of (i) the occurrence of overheating of the stator winding and (ii) the occurrence of arcs, the bolt is displaced from the recess of the motor shaft.

20. The synchronous machine as claimed in claim 19, wherein the retaining element is comprises a bandage radially surrounding an outside of the ring.

21. The synchronous machine as claimed in claim 19, wherein the connecting element includes at least one compression spring, via which a force directed radially outwards is exerted on the bolt.

22. The synchronous machine as claimed in claim 20, wherein the connecting element includes at least one compression spring, via which a force directed radially outwards is exerted on the bolt.

23. The synchronous machine as claimed in claim 14, wherein the rotor is supported to rotate on the motor shaft;
wherein the connecting device comprises a first coupling device, which is arranged on the motor shaft in a torsion-proof manner;
wherein the connecting device comprises a second coupling device, which is connected to the rotor in a torsion-proof manner;
wherein the connecting device comprises a retaining element radially enclosing the first coupling device and the second coupling device, via which the first coupling device is initially pressed axially onto the second coupling device, such that the torque generated by the interaction of the stator winding and the permanent magnets is transmitted to the motor shaft by the interaction of first and second coupling element; and
wherein the retaining element consists at least partly of a material, of which at least one of (i) the strength and (ii) the cohesion, in the event of the short circuit of the stator winding, is reduced such that, by at least one of (i) the occurrence of overheating of the stator winding and (ii) the occurrence of arcs, a pressure exerted by the retaining element on the first and the second coupling element is reduced such that a displacement of the first and the second coupling element away from each other occurs.

24. The synchronous machine as claimed in claim 23, wherein the retaining element comprises a plurality of bandages.

25. The synchronous machine as claimed in claim 23, wherein the retaining element further comprises a plurality of bolts, which are secured at both axial ends by fixing elements; and
wherein the fixing elements consist of a material of which at least one of (i) the strength and (ii) the cohesion is reduced, in the event of the short circuit of the stator winding, by at least one of (i) the occurrence of overheating of the stator winding and (ii) the occurrence of arcs.

26. The synchronous machine as claimed in claim 23, wherein at least one compression spring is arranged between the first and the second coupling element, via which a force is exerted on the first and the second coupling elements, driving the first and the second coupling elements away from one another.

27. The synchronous machine as claimed in claim 24, wherein at least one compression spring is arranged between the first and the second coupling element, via which a force is exerted on the first and the second coupling elements, driving the first and the second coupling elements away from one another.

28. The synchronous machine as claimed in claim 25, wherein at least one compression spring is arranged between the first and the second coupling element, via which a force is exerted on the first and the second coupling elements, driving the first and the second coupling elements away from one another.

29. The synchronous machine as claimed in claim 19, further comprising:
a bearing formed as an emergency bearing via which the rotor is supported on the motor shaft.

30. A land vehicle, comprising
a plurality of propulsion drives, each the propulsion drives having the synchronous machine as claimed in claim 14;
wherein at least one wheel of the land vehicle is driven via the synchronous machine in each case.
